(19) United States
(12) Patent Application Publication
(10) Pub. No.: US 2013/0322516 A1
(43) Pub. Date: Dec. 5, 2013

(54) SYSTEMS AND METHODS FOR GENERATING MULTIPLE BITRATE STREAMS USING A SINGLE ENCODING ENGINE

(71) Applicant: Lei Zhang, Palo Alto, CA (US)

(72) Inventor: Lei Zhang, Palo Alto, CA (US)

(73) Assignee: BROADCOM CORPORATION, Irvine, CA (US)

(21) Appl. No.: 13/484,478

(22) Filed: May 31, 2012

(51) Int. Cl. H04N 7/32; H04N 7/26

(52) U.S. Cl. 375/240.02; 375/E07.154

(57) ABSTRACT

Various embodiments are disclosed for generating multiple output bitrates of a video processing device for encoding video. The method comprises receiving video data comprising a plurality of frames encoding, by a single encoding engine, the received video data to generate a plurality of bitstreams corresponding to different bitrates by sharing such coding decisions as which motion vectors to retrieve, intra-mode prediction, and intra and inter-mode decisions. The method further comprises determining an available network bandwidth for transmitting encoded video and transmitting one or more of the plurality of bitstreams generated by the single encoding engine based on the determined available bandwidth.

### BACKGROUND

Digital video capabilities may be incorporated into a wide range of devices including, for example, digital televisions, digital direct broadcast systems, digital recording devices, gaming consoles, digital cameras and various handheld devices, such as mobile phones. Video data may be received and/or generated by a video processing device and delivered to a display device such as, for example, a set-top-box where the video processing device may comprise a computer, a camera, disk player, etc. Uncompressed video may be transmitted from a video processing unit to a display or television using various media and/or formats.

The utilization of a real-time video encoder or transcoder to stream video over the Internet for such applications as live video conferencing over an IP network requires the real-time encoder to adapt its output bitrate of the compressed video stream to meet the real-time network transmission bandwidth. This presents a challenge for a real-time encoder to support adapting bitrates quickly when the network bandwidth drops, mainly due to latency associated with an encoding pipeline.

In a video conference system, for example, different users may have different levels of available network bandwidth for receiving video streams from other users. As such, a video stream source may need to generate video streams of multiple bitrates to facilitate the transmission of video to multiple receivers each with different network bandwidth. The senders of a video stream may also be limited by the available bandwidth for transmitting video streams. There are also video networking systems where the source of video streams need to generate and transmit live video streams of multiple bitrate in real-time simultaneously. For example, with the utilization of a real-time video encoder for security monitors, a high bitrate stream may be transmitted to a live video monitor (i.e., a first receiver) while a low bitrate stream may be stored to a storage device (i.e., a second receiver) such as hard disk drive in order to archive video.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a networked environment in which embodiments of a video processing device for facilitating the adaptive selection of an encoded bitstream may be implemented in accordance with various embodiments of the present disclosure.

FIG. 2 is a detailed view of the video processing device of FIG. 1 in accordance with various embodiments of the present disclosure.

FIG. 3 is a detailed block diagram of the encoding engine in FIG. 2 for facilitating the adaptive selection of an encoded bitstream in accordance with various embodiments of the present disclosure.

FIG. 4 is a top-level flowchart illustrating examples of functionality implemented as portions of the video processing device of FIG. 1 for facilitating the adaptive selection of an encoded bitstream according to various embodiments of the present disclosure.

FIG. 5 is a top-level flowchart illustrating examples of functionality implemented as portions of the video processing device of FIG. 1 for facilitating the adaptive selection of an encoded bitstream according to other embodiments of the present disclosure.

FIG. 6 is a flowchart illustrating examples of the encoding operation in the flowchart of FIG. 5 performed by the single encoding engine of FIG. 2 according to various embodiments of the present disclosure.

FIG. 7 is a schematic block diagram of the video processing device in FIG. 1 according to an embodiment of the present disclosure.

### DETAILED DESCRIPTION

Challenges arise for a real-time encoder attempting to adapt bitrates quickly when the network bandwidth drops, mainly due to latency associated with an encoding pipeline. One approach to addressing this issue is to implement multiple encoding engines to perform real-time encoding of the same input video at multiple bitrates in parallel so that when the network bandwidth drops, the encoder simply makes a selection and transmits one of the compressed video streams with a corresponding bitrate that is no higher than the available bandwidth. When higher network bandwidth becomes available, the encoder then selects the stream corresponding to a higher bitrate in order to provide better quality. However, the cost of implementing multiple encoding engines is significant.

Another approach is to configure an encoder to downscale the input video to be encoded to a lower bitrate. This approach, however, also requires a separate encoding engine to encode the downscaled video. As yet another approach, the encoder may be configured to reduce the encoded picture rate. The encoder may also selectively discard portions of the compressed bitstream to match the available network bandwidth. However, discarding portions of the bitstream is generally not a preferable approach.

Various embodiments are disclosed for utilizing a single encoding engine to generate multiple streams corresponding to multiple bitrates for the same input video. In accordance with various embodiments, compression coding decisions among the various streams are shared, thereby avoiding the need to perform spatial scaling, temporal picture dropping, etc. on a stream-by-stream basis. Such coding decisions as the selection of inter-mode prediction versus intra-mode prediction for processing a given macroblock, the partitioning of the macroblock used in the prediction process, the selection of motion vectors to retrieve for all partitions for inter-prediction mode, the determination of prediction directions for macroblocks in intra-prediction mode, and so on are shared so that multiple bitstreams are encoded using a single encoding engine.

In this regard, one embodiment, among others, is a method implemented in a video processing device for encoding video. The method comprises receiving video data comprising a plurality of frames and encoding, by a single encoding engine, the received video data to generate a plurality of bitstreams corresponding to different bitrates. The method further comprises determining an available network bandwidth for transmitting encoded video and transmitting one or more of the plurality of bitstreams generated by the single encoding engine based on the determined available bandwidth. While for some applications, the video processing device may transmit a single bitstream, in other applications, the video processing device may transmit multiple bitstreams. To illustrate, consider a video conference system, for example, where different users participating in a video conference call may have different levels of available network bandwidth for receiving video streams from other users. As such, a video processing device may need to generate video streams of multiple bitrates to facilitate the transmission of video to receivers with different network bandwidth.

Implementation of the disclosed embodiments results in significant savings with respect to silicon area cost in an application specific integrated circuit (ASIC) implementation. Significant savings with respect to processing power for GPU-based software implementation may also be realized, in addition to reduction in DRAM bandwidth for motion searches as compared to implementations that utilize multiple encoding engines to generate multiple bitstreams.

For some embodiments, a single encoding engine is utilized to generate multiple streams of compressed video, wherein each generated stream has a corresponding processing unit for generating residuals and for subsequently generating the quantized transformed coefficients to be used in applying the shared coding decisions. In accordance with various embodiments, each stream is assigned a different quantization parameter, where a relatively higher quantization parameter is applied for relatively lower bitrate bitstreams, whereas a relatively lower quantization parameter is applied for relatively higher bitrate bitstreams.

Furthermore, each processing unit also performs inverse quantization and inverse transform operations in order to produce corresponding reconstructed pixels. For some embodiments, the coding decisions shared by all the output streams may be made based on the reconstructed pixels of the stream of the highest bitrate or the original input pixels. However, coding decisions can also be made based on the reconstructed pixels of the stream associated with any one of the lower bitrates, although the resulting coding decisions may not be optimal for encoding the bitstream associated with the highest bitrate. In the following discussion, a general description of the system and its components is provided, followed by a discussion of the operation of the same.

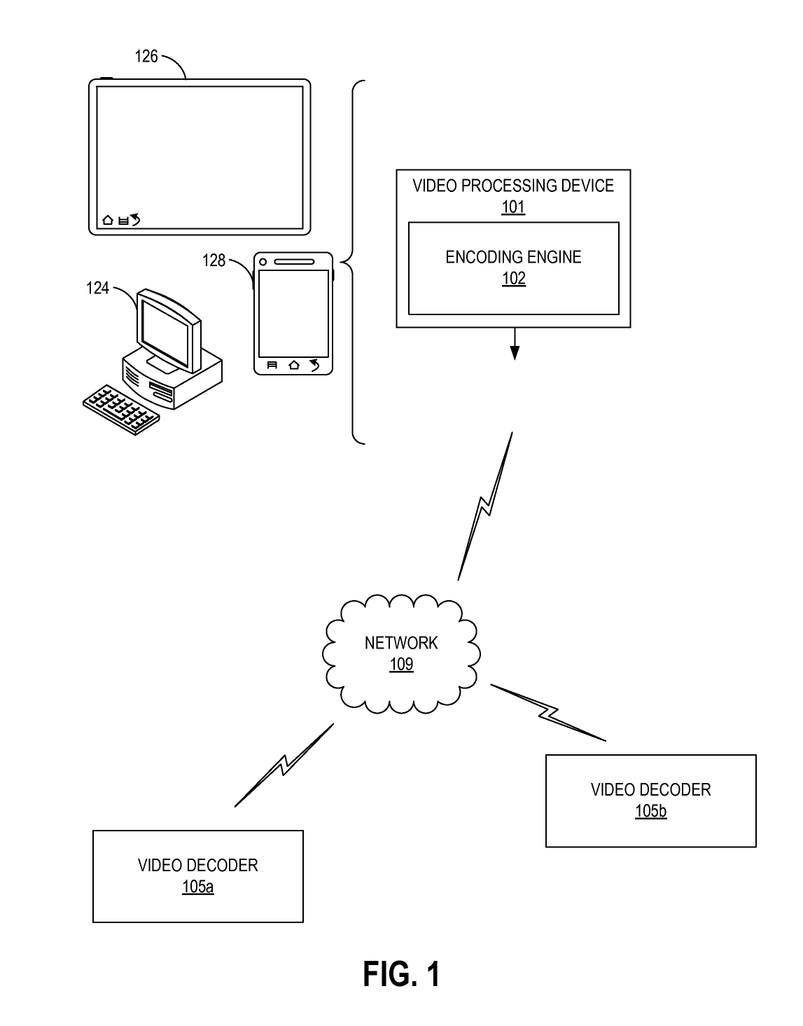

Reference is made to FIG. 1, which is a block diagram of a networked environment in which embodiments of a video processing device for facilitating the adaptive selection of encoding tools may be implemented in accordance with various embodiments of the present disclosure. The video processing device 101 may be embodied, for example, as a computing device, such as by way of example and without limitation, a desktop computer 124, a tablet 126, a smartphone 128, a set top box (STB) (not shown), a media player (not shown), video conferencing system (not shown), or other device.

Applications, logic, and/or other functionality may be executed in the video processing device 101 according to various embodiments. The components executed on the video processing device 101 include, for example, a single encoding engine 102 configured to generate multiple bitstreams of multiple bitrates from the same input video. As shown, the video processing device 101 may be coupled to a network 109 for transmitting encoded video data to one or more video decoders 105a, 105b also coupled to the network 109. The video processing device 101 may be configured to stream video over the Internet for such applications as live video conferencing over an IP network, whereby one or more video decoders 105a, 105b coupled to the network 109 are configured to receive and decode the streaming video.

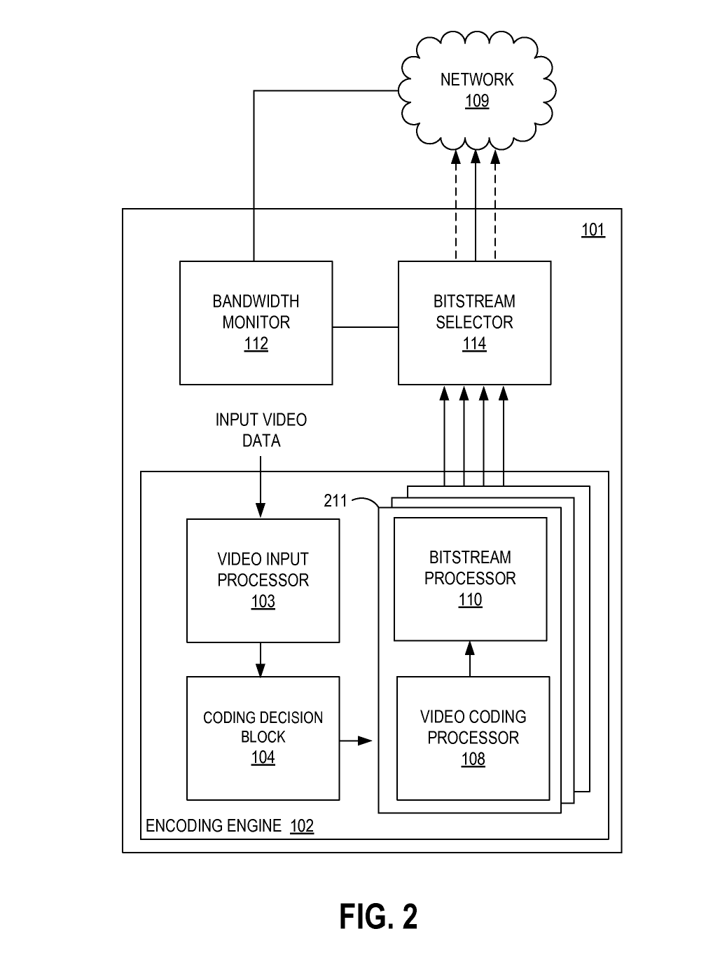

Reference is made to FIG. 2, which provides a detailed view of the video processing device 101 of FIG. 1 in accordance with various embodiments of the present disclosure for facilitating the adaptive selection of an output bitrate of a video bitstream. In accordance with some embodiments, the video processing device 101 includes a single video encoding engine 102, where the encoding engine 102 comprises a video input processor 103, a coding decision block 104, processing units 211 that each comprise a video coding processor 108, and a bitstream processor 110, where the video coding processor 108 includes multiple motion compensation blocks for processing multiple streams.

The video input processor 103 is configured to capture and process input video data and transfers the video data to the coding decision block 104, where the coding decision block 104 analyzes the motion in frames of the input video signal. The coding decision block 104 transfers the input video signal and the results of motion analysis to the plurality of processing units 211, where a video coding processor 108 within each respective processing unit 211 processes the prediction and compresses the video signal based on the intra prediction decision and the motion analysis performed by the coding decision block 104.

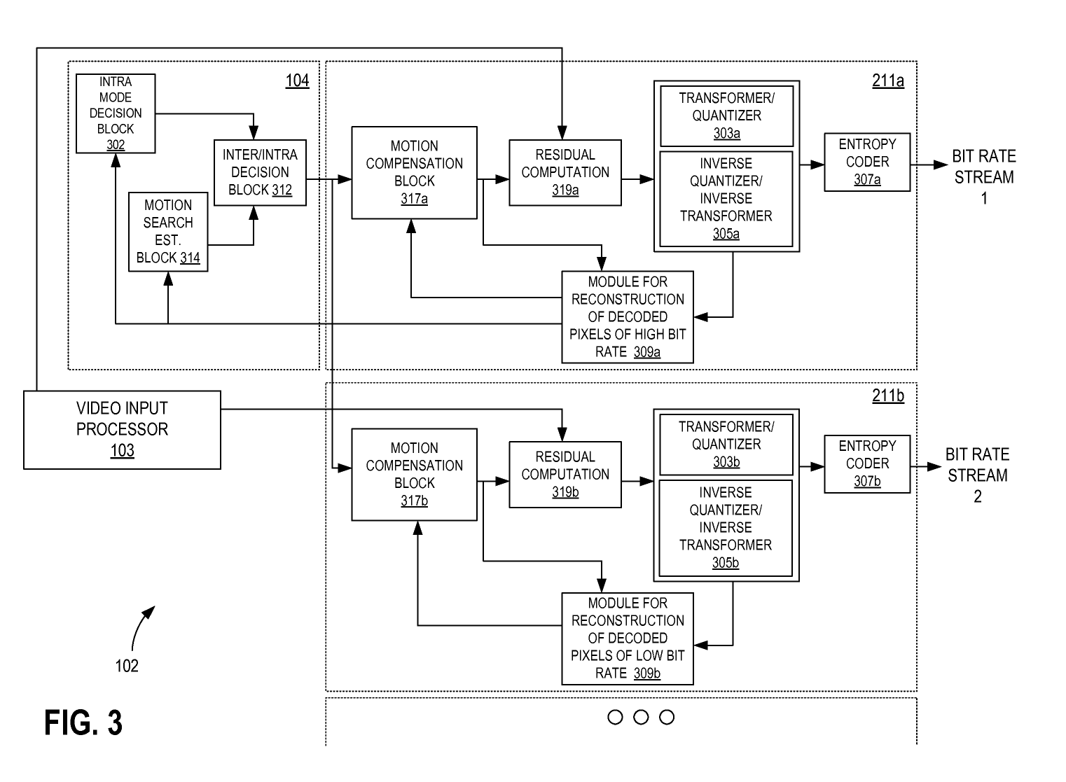

Referring briefly to FIG. 3, the video coding processor 108 (FIG. 2) transfers the compressed video data to the bitstream processor 110 (FIG. 2), which formats the compressed data and creates multiple encoded video bitstreams corresponding to different bitrates, where the intra-mode decision performed by the intra-mode decision block 302, the inter/intra coding decision performed by the inter/intra decision block 312, and the motion search performed by the motion search estimation block 314 within the coding decision block 104 are shared and utilized for generating the multiple bitstreams.

Referring back to FIG. 2, the bitstream processors 110 in the processing unit 211 output the multiple bitstreams to a bitstream selector 114, which is configured to select one or more of the bitstreams based on, for example, the real-time network transmission bandwidth available to the video processing device 101 for transmitting video data. As shown, the bitstream selector 114 is coupled to a bandwidth monitor 112 configured to monitor the real-time network transmission bandwidth that is available. One of ordinary skill in the art will appreciate that the encoding engine 102 may comprise other components which have been omitted for purposes of brevity. While the embodiment in FIG. 2 includes a bandwidth monitor 112 and bitstream selector 114 that determines which bitstream(s) to transmit, for other embodiments, the selection of the bitstream(s) may be based on a request received from the far end at the video receiver side.

In comparison to existing encoder systems, embodiments of the video processing device 101 utilize the single encoding engine 102 disclosed herein to generate streams of multiple bitrates of the same input video without the need for spatial scaling or dropping of temporal picture information by sharing the same coding decisions, such as, but not limited to, the selection of inter-mode prediction versus intra-mode prediction for a given macroblock, partitioning of a macroblock used in the prediction process, the selection and retrieval of motion vectors of all partitions for inter-mode prediction, prediction directions corresponding to macroblocks for intra-mode prediction.

In accordance with various embodiments, the bandwidth monitor is configured to monitor the network bandwidth available to the video processing device 101 for transmission of compressed video data and communicate this information to the bitstream selector 114, which selects one or more of the plurality of generated bitstreams output by the bitstream processor 110 to adaptively adjust the transmission bitrate based on the determined available bandwidth. Note, however, that this is just one example application. In accordance with some embodiments, the video processing device 101 may be configured to receive requests from video decoders 105a, b (FIG. 1), where the bitstream selector 114 selects one or more of the generated bitstreams based on the requests received by the video processing device 101.

Reference is made to FIG. 3, which illustrates an embodiment of the single encoding engine 102 of FIG. 2. Video is received by the video input processor 103 and forwarded to the coding decision block 104, where such coding decisions as the selection of inter-mode prediction versus intra-mode prediction by the intra-mode decision block 302 and the inter/intra decision block 312 for processing a given macroblock, the partitioning of the macroblock used in the prediction process, which motion vectors to retrieve by the motion compensation block 317a, b for all partitions for inter-prediction mode (where the partitions and their associated motion vectors to retrieve are identified by the motion search block 314), the determination of prediction directions for macroblocks in intra-prediction mode, and so on are made.

As shown, the compression coding decisions are shared among multiple processing units 211a, 211b, where each processing unit 211a, 211b generates a bitstream (e.g., “bitstream 1” and bitstream 2”) corresponding to a different bitrate. For purposes of illustration, the single encoding engine 102 is shown as generating two bitstreams. However, embodiments of the single encoding engine 102 are not so limited and may be expanded to generate any number of bitstreams. The number of bitstreams may depend, for example, on the application executing on the video processing device 101 (FIG. 1), where the application may comprise a video conferencing application or other application for streaming video data over the Internet.

During the encoding process, a current frame or picture in a group of pictures (GOP) is provided for encoding. The current picture may be processed as macroblocks or coding units in the emerging video coding standard HEVC, where a macroblock or a coding unit corresponds to, for example, a 16×16 or 32×32 block of pixels in the original image. Each macroblock may be encoded in intra-coded mode or in inter-coded mode for P-pictures, or B-pictures. In inter-coded mode, the motion compensated prediction may be performed by the corresponding motion compensation block 317a, 317b in each processing unit 211a, 211b and may be based on at least one previously encoded, reconstructed picture.

For each processing unit 211a, 211b, the predicted macroblock P may be subtracted from the current macroblock to generate a difference macroblock, and the difference macroblock may be transformed and quantized by the corresponding transformer/quantizer block 303a, 303b for each bitstream. The output of each transformer/quantizer block 303a, 303b may be entropy encoded by the corresponding entropy encoder 307a, 307b and output as a compressed bitstream that corresponds to a different bitrate.

The encoded video bitstreams (e.g., “bitstream 1” and “bitstream 2”) comprise the entropy-encoded video contents and any side information necessary to decode the macroblock. During the reconstruction operation for each of the bitstreams, the results from the corresponding transformer/quantizer block 303a, 303b may be re-scaled and inverse transformed by a corresponding inverse quantizer/inverse transformer 305a, 305b to generate a reconstructed difference macroblock for each bitstream. The prediction macroblock P may be added to the reconstructed difference macroblock.

In this regard, each bitstream is associated with a corresponding processing unit 211a, 211b which include residual computation blocks 319a, 319b each configured to generate residuals and subsequently, the quantized transformed coefficients, where as shown, the coding decisions are shared. Note, however, that different quantization parameters are applied. Each processing unit 211a, 211b further comprises a reconstruction module 309a, 309b coupled to the inverse quantizer/inverse transformer block 305a, 305b, where each reconstruction modules 309a, 309b is configured to generate corresponding reconstructed pixels. As shown, the reconstruction modules 309a, 309b perform the reconstruction of decoded pixels at different bitrates, depending on the corresponding quantization parameter that is applied.

For some embodiments, the coding decisions that are shared may be made based on the reconstructed pixels of the bitstream associated with the highest bitrate (which corresponds to the lowest quantization level). For other embodiments, the coding decision that are shared may be made based on the reconstructed pixels of the bitstream corresponding to a lower bitrate (which corresponds to a higher quantization level), although the resulting coding decision may not be optimal for the bitstream corresponding to a higher bitrate.

In accordance with various embodiments, other coding decisions such as the search range and resolution level for fine motion estimation may be shared among the different processing units. Note that the various embodiments disclosed may be applied to various video standards, including but not limited to, MPEG-2, VC-1, VP8, and HEVC, which offers more encoding tools that may be shared. For example, with HEVC, the inter-prediction unit size can range anywhere from a block size of 4×4 up to 32×32, which requires a significant amount of data to perform motion search and motion compensation.

Note also that the various embodiments directed to sharing of coding decisions are not limited to the selection of bi-predictive coding versus uni-predictive coding. Other coding parameters or coding sources that may be selected may include the size of the coding unit associated with a generalized B-picture in HEVC in addition to the selection of intra-coding or inter-coding, the selection of bi-prediction versus uni-prediction for inter-coding, and so on.

Other encoding tools or parameters that may be shared include the search range for coarse motion estimation, the number of references in coarse motion estimation searches, the frame motion vector range or resolution, a partition size to be accessed by the macroblock or coding unit, and so on, where these and other coding decisions are shared among the different processing units 211a, 211b to generate different bitstreams corresponding to different bitrates, where the output bitrate is adaptively selected based on the network conditions as determined by the bandwidth monitor 112 (FIG. 2). It should be emphasized, however, that the selection of the output bitrate is not limited to network conditions as other criteria for selecting the output bitrate may also be applied.

In accordance with various embodiments, the bandwidth monitor 112 (FIG. 2) is configured to monitor the network 109 (FIG. 2) and provide one or more feedback signals to the bitstream selector 114 (FIG. 2), which the bitstream selector 114 utilizes to select one of the plurality of bitstreams generated by the different processing units 211a, 211b of the single encoding engine 102. In this regard, the feedback signals generated by the bandwidth monitor 112 allow the bitstream selector 114 to adaptively increase or decrease the output bitrate of the video processing device 101 by directing the selection of an appropriate bitstream to meet current network bandwidth conditions.

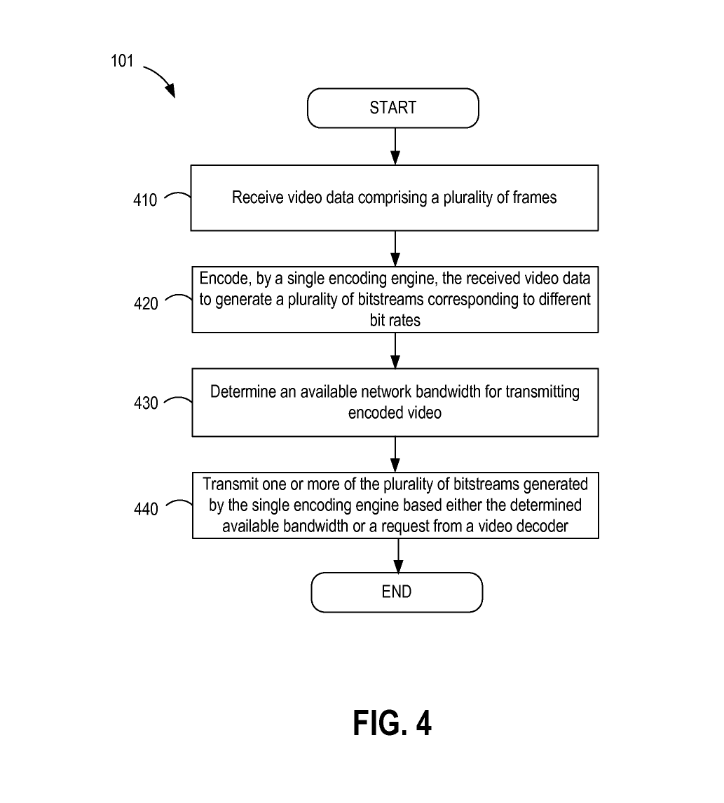

Reference is made to FIG. 4, which is a flowchart in accordance with an embodiment of a method for adaptively adjusting the output bitrate of the video encoding engine 102 (FIG. 1), wherein the method is executed in the video processing device 101 (FIG. 1). It is understood that the flowchart of FIG. 4 provides merely an example of the various different types of functional arrangements that may be employed. As an alternative, the flowchart 400 of FIG. 4 may be viewed as depicting an example of steps of a method implemented via execution of the video processing device 101 according to one or more embodiments.

In accordance with one embodiment for adaptively adjusting the transmission bitrate, the video processing device 101 begins with block 410 and receives video data comprising a plurality of frames. In block 420, the single encoding engine 102 in the video processing device 101 encodes the received video data to generate a plurality of bitstreams corresponding to different bitrates. For some embodiments, the number of bitstreams may be determined and set according to one or more applications executing in the video processing device 101, where the video processing device 101 streams video over the Internet for such applications as live video conferencing over an Internet protocol (IP) network.

In accordance with various embodiments, encoding the received video data according to a plurality of bitrates may comprise, for example, partitioning each video frame into a plurality of macroblocks or coding units and determining a prediction coding mode associated with each macroblock or coding unit, where the partitioning of each video frame and the determined prediction code mode are shared and utilized by the single encoding engine 102 for encoding each of the plurality of bitstreams. Other coding decisions that may be shared and utilized for encoding multiple bitstreams include a search range/resolution level for fine motion estimation, a block partition size for performing motion searches and motion compensation, coding unit size, the selection of intra-coding versus inter-coding, the selection of bi-prediction versus uni-prediction for inter-coding, the selection of a single reference search versus a two reference search for uni-prediction coding, and so on.

In block 430, the bandwidth monitor 112 (FIG. 2) monitors network conditions and determines an available network bandwidth for transmitting encoded video. In block 440, the bitstream selector 114 (FIG. 2) transmits one of the plurality of bitstreams generated by the single encoding engine 102 based on the available bandwidth determined by the bandwidth monitor 112 or based on a request from a video decoder 105a, 105b (FIG. 1).

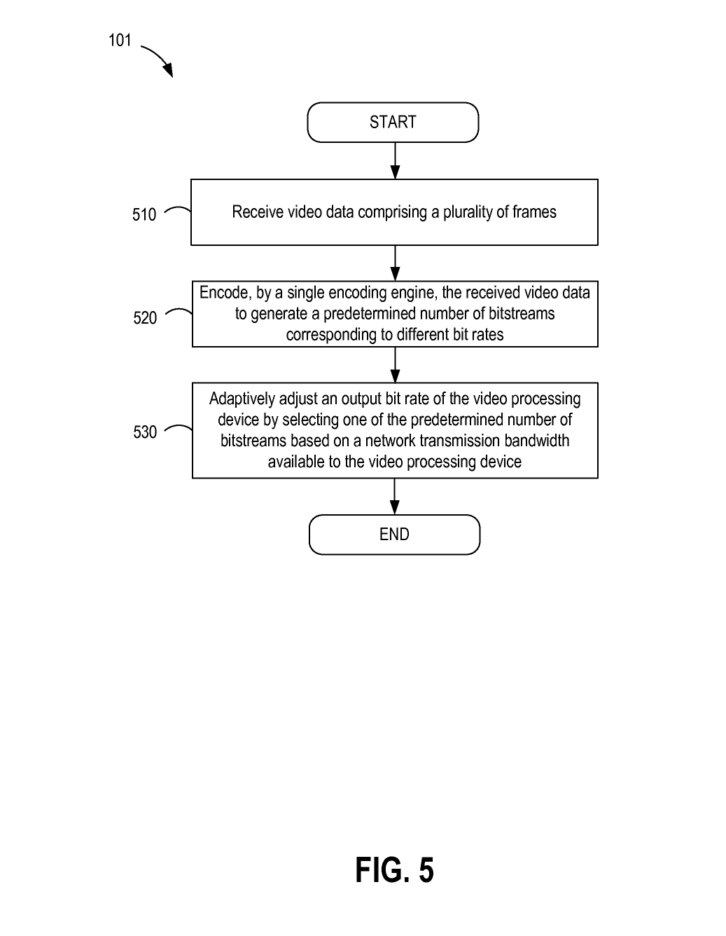

Reference is made to FIG. 5, which is a flowchart in accordance with an alternative embodiment of a method for adaptively adjusting the output bitrate of the video encoding engine 102 (FIG. 1), wherein the method is executed in the video processing device 101 (FIG. 1). It is understood that the flowchart of FIG. 5 provides merely an example of the various different types of functional arrangements that may be employed. As an alternative, the flowchart of FIG. 5 may be viewed as depicting an example of steps of a method implemented via execution of the video processing device 101 according to one or more embodiments.

In accordance with one embodiment for adaptively adjusting the transmission bitrate, the video processing device 101 begins with block 510 and receives video data comprising a plurality of frames. In block 520, the single encoding engine 102 encodes the received video data to generate a predetermined number of bitstreams corresponding to different bitrates.

In block 530, the output bitrate of the video processing device 101 is adaptively adjusted by selecting one of the predetermined number of bitstreams based on a network transmission bandwidth available to the video processing device 101 for streaming video. Note that the disclosed embodiments may be applied to any video encoding standard, including VP8, which is a popular standard to stream video-over-Internet, and the emerging HEVC standard, where coding decisions require significant amount of processing power.

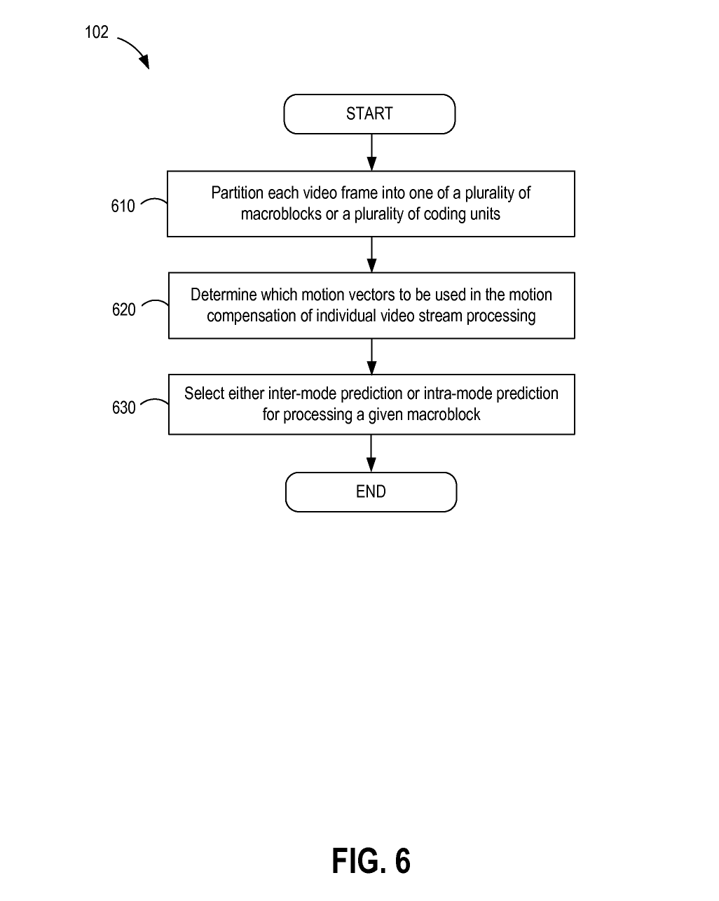

FIG. 6 is a flowchart illustrating examples of the encoding operation in the flowchart of FIG. 5 performed by the single encoding engine 102 (FIG. 2) according to various embodiments of the present disclosure. With reference to block 520 in FIG. 5, the single encoding engine 102 encodes the received video data to generate multiple bitstreams. In particular, in block 610, the coding decision block 104 in the single encoding engine 102 partitions each video frame into one of a plurality of macroblocks or a plurality of coding units. In block 620, the coding decision block 104 determines which motion vectors to be used in the motion compensation of individual video stream processing.

In block 630, the coding decision block 104 selects either inter-mode prediction or intra-mode prediction for processing a given macroblock. Note that the partitioning of each video frame, the determined prediction mode, which motion vectors to use in motion compensation, and other coding decisions are utilized by the single encoding engine for encoding each of the plurality of bitstreams.

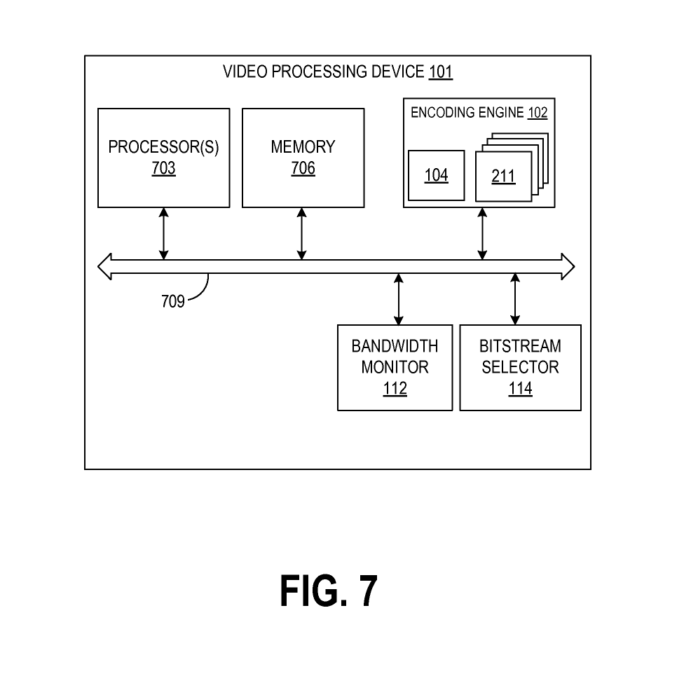

FIG. 7 is a schematic block diagram of a video processing device 101 according to various embodiments of the present disclosure. The video processing device 101 includes a processor 703, a memory 706, a video encoding engine 102, a bandwidth monitor 112, and a bitstream selector 114, all of which are coupled to a local interface 709. To this end, the video processing device 101 may comprise, for example, at least one computing device or like device. The video encoding engine 102 includes, among other components, a coding decision block 104 and a plurality of processing units (e.g., 211a, 211b in FIG. 2), as described earlier. The local interface 709 may comprise, for example, a data bus with an accompanying address/control bus or other bus structure as can be appreciated.

The video encoding engine 102 may be implemented as a board level product, as a single chip, application specific integrated circuit (ASIC), and so on. Alternatively, certain aspects of the present invention are implemented as firmware. Stored in the memory 706 are both data and several components that are executable by the processor 703. It is understood that there may be other systems that are stored in the memory 706 and are executable by the processor 703 as can be appreciated. A number of software components are stored in the memory 706 and are executable by the processor 703. In this respect, the term “executable” means a program file that is in a form that can ultimately be run by the processor 703.

Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), and/or other memory components, or a combination of any two or more of these memory components. In addition, the RAM may comprise, for example, static random access memory (SRAM), dynamic random access memory (DRAM), or magnetic random access memory (MRAM) and other such devices.

Also, the processor 703 may represent multiple processors 703 and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction. In one embodiment, the processor 703 and memory 706 may correspond to a system-on-a-chip.

Although the video encoding engine 102, the bandwidth monitor 112, the bitstream selector 114, and other components described herein may be embodied in software or code executed by general purpose hardware as discussed above, as an alternative, the same may also be embodied in dedicated hardware or a combination of software/general purpose hardware and dedicated hardware. If embodied in dedicated hardware, each component may be implemented as a circuit or state machine that employs any one of or a combination of a number of technologies. These technologies may include, but are not limited to, discrete logic circuits having logic gates for implementing various logic functions upon an application of one or more data signals, ASICs having appropriate logic gates, or other components, etc. Such technologies are generally well known by those skilled in the art and, consequently, are not described in detail herein.

The flowcharts of FIGS. 4 and 5 show the functionality and operation of an implementation of portions of the video processing device 101. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. It is understood that all such variations are within the scope of the present disclosure.

Also, any logic or application described herein that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method for encoding video in a video processing device, comprising:
receiving video data comprising a plurality of frames;
encoding, with a single encoding engine, the received video data to generate a plurality of bitstreams corresponding to different bitrates; and
transmitting one of the plurality of bitstreams generated by the single encoding engine based on one of: a determined available bandwidth and a request from a video decoder.

2. The method of claim 1, wherein encoding the received video data according to a plurality of bitrates comprises:
partitioning each video frame into one of a plurality of macroblocks or a plurality of coding units; and
determining a prediction coding mode associated with each macroblock, wherein the partitioning of each video frame and the determined prediction code mode are utilized by the single encoding engine for encoding each of the plurality of bitstreams.

3. The method of claim 2, wherein determining the prediction coding mode comprises selecting one of inter-mode prediction or intra-mode prediction.

4. The method of claim 3, wherein determining the prediction coding mode further comprises:
in response to selection of inter-mode prediction, selecting one of bi-predictive coding or uni-predictive coding.

5. The method of claim 4, wherein determining the prediction coding mode further comprises:
in response to selection of uni-predictive coding, selecting one of a single reference search or a multi-reference search.

6. The method of claim 3, further comprising responsive to selection of inter-mode prediction, searching motion vectors for all partitions of a macroblock in the received video data.

7. The method of claim 3, further comprising:
in response to selection of intra-mode prediction, determining a prediction direction for a current macroblock.

8. The method of claim 1, further comprising prior to encoding, determining the number of bitstreams to generate based on an application executing on the video processing device for streaming video data.

9. The method of claim 1, wherein the request from the video decoder comprises a request for the video processing device to transmit multiple bitstreams at different bitrates.

10. A video processing system for encoding video, comprising:
a video input processor configured to receive video data comprising a plurality of frames;
a single encoding engine configured to encode the received video data and generate a plurality of bitstreams corresponding to different bitrates;
a bandwidth monitor configured to determine an available network bandwidth for transmitting the encoded video; and
a bitstream selector configured to transmit one of the plurality of encoded bitstreams based on the determined available bandwidth.

11. The system of claim 10, further comprising a plurality of processing units each configured to perform inverse quantization and an inverse transform operation to generate reconstructed pixels, where each of the plurality of processing units is further configured to perform run-length encoding and entropy encoding to generate a corresponding encoded bitstream.

12. The system of claim 11, wherein the number of processing units is equal to the number of bitstreams.

13. The system of claim 11, wherein the single encoding engine further comprises a prediction mode selector configured to select one of inter-mode prediction or intra-mode prediction, wherein the prediction mode selector is further configured to partition a macroblock of the video data for the selected prediction mode.

14. The system of claim 13, wherein the selection by the prediction mode selector is applied in generating the plurality of bitstreams corresponding to the different bitrates.

15. The system of claim 13, wherein the prediction mode selector is further configured to select motion vectors of all partitions for inter-prediction mode.

16. The system of claim 13, wherein the prediction mode selector is further configured to determine a inter prediction direction for a current macroblock.

17. The system of claim 13, wherein the prediction mode selector in the single encoding engine selects one of inter-mode prediction or intra-mode prediction based on reconstructed pixels corresponding to the bitstream with a highest relative bitrate.

18. The system of claim 13, wherein the prediction mode selector in the single encoding engine selects one of inter-mode prediction or intra-mode prediction based on reconstructed pixels corresponding to the bitstream with a relatively lower bitrate.

19. The system of claim 10, wherein the bandwidth monitor is configured to determine the available network bandwidth for transmitting encoded video based on an application executing on the video processing system for streaming video data.

20. A method for encoding video in a video processing device, comprising:
receiving video data comprising a plurality of frames;
encoding, by a single encoding engine, the received video data to generate a predetermined number of bitstreams corresponding to different bitrates; and
adaptively adjusting an output bitrate of the video processing device by selecting one of the predetermined number of bitstreams based on one of: a network transmission bandwidth available to the video processing device and a request from a video decoder.

21. The method of claim 1, wherein encoding the received video data according to a plurality of bitrates comprises:
determining compression coding decisions; and
utilizing the determined compression coding decisions for encoding each of the predetermined number of bitstreams.
